(19) United States
(12) Patent Application Publication
(10) Pub. No.: US 2024/0087370 A1
(43) Pub. Date: Mar. 14, 2024

(54) METHOD FOR DETECTING THE STATE OF A VEHICLE COMPONENT

(71) Applicant: Continental Automotive Technologies GmbH, Hannover (DE)

(72) Inventors: Stefan Dreiseitel, Oberursel (DE); Timo Schröder, Ginsheim-Gustavsburg (DE)

(73) Assignee: Continental Automotive Technologies GmbH, Hannover (DE)

(21) Appl. No.: 18/264,255

(22) PCT Filed: Jan. 28, 2022
(86) PCT No.: PCT/DE2022/200011

§ 371 Date: Aug. 4, 2023

(30) Foreign Application Priority Data
Feb. 4, 2021 (DE) 10 2021 201 041.5

(51) Int. Cl. G07C 5/00

(52) U.S. Cl. CPC G07C 5/008

(57) ABSTRACT

A system for detecting a state of a vehicle component comprises a server computer and a vehicle having the vehicle component. The vehicle has a control computer for controlling the vehicle component and for detecting vehicle data which describe the state of the vehicle component. Furthermore, the vehicle comprises a data transmission device for transmitting the vehicle data to the server computer. The server computer is configured to receive the vehicle data and to evaluate the vehicle data. The server computer is configured to establish a state of the vehicle component by evaluating the vehicle data.

### CROSS-REFERENCE TO RELATED APPLICATIONS

The present application is a National Stage Application under 35 U.S.C. § 371 of International Patent Application No. PCT/DE2022/200011 filed on Jan. 28, 2022, and claims priority from European Patent Application No. 10 2021 201 041.5 filed on Feb. 4, 2021, in the German Patent and Trademark Office, the disclosures of which are herein incorporated by reference in their entireties.

### BACKGROUND

### 1. Field

Aspects and objects of embodiments of the present application relate to a system for detecting a state of a vehicle component of a vehicle in order to monitor and judge the integrity and road safety of the vehicle.

### 2. Description of Related Art

Nowadays, the driver of a vehicle is substantially responsible for the integrity, safety and roadworthiness, in particular the conformity of the vehicle with prescribed regulations or standards. Consequently, the driver must himself judge whether the vehicle and its systems are functioning correctly and whether they meet the imposed road safety conditions before and during a journey.

The road safety requirements of a vehicle and its systems are usually prescribed by law by way of regulations and standards. Compliance with said regulations is usually monitored at specific intervals within the framework of an inspection by authorized personnel from an official test center, for example the TUV or DEKRA in Germany. The inspection of the vehicle and its systems is, as a general rule, carried out on site at the accredited test center. Consequently, the vehicle has to be regularly presented to a tester.

Today's vehicles and their internal vehicle components are already very complex, meaning that defective system behavior and the resulting consequences can, in general, only be ascertained and predicted with great difficulty by a driver. As a result of the increasing omission of mechanically coupled human-machine interfaces such as, by way of example, the steering wheel, the brake or accelerator pedal or other wired systems, it is becoming increasingly difficult for a driver to recognize the wear state of a system or even a defect in the system. The future development towards autonomous/highly automated driving and/or the joint utilization of a vehicle by various drivers will only compound this problem.

In the case of the existing vehicle systems nowadays and, in particular, in the case of future systems, a driver or vehicle owner can only/will only be able to recognize an alteration in the vehicle state due to wear, a defect or other events such as, by way of example, manipulation, an accident or hacking with difficulty, or at least only gauge said alteration with a great deal of uncertainty.

The judgement of the state of a vehicle component and the interaction of said vehicle components also requires additional specialist knowledge, special tools and increased testing outlay in the field of vehicle maintenance and judgement of roadworthiness by official testers.

### SUMMARY

According to an aspect of an embodiment, there is provided a system for detecting a state of a vehicle component, with which the state of the vehicle component can be safely detected and reliably judged in order to, consequently, reliably assess the integrity of the vehicle component and the road safety of the entire vehicle.

The system comprises a server computer and a vehicle having the vehicle component. The vehicle has a control computer for controlling the vehicle component and for detecting vehicle data which describe the state of the vehicle component. Furthermore, the vehicle has a data transmission device for transmitting the vehicle data to the server computer. The server computer is configured to receive the vehicle data and to evaluate the vehicle data. Furthermore, the server computer is configured to establish a state of the vehicle component by evaluating the vehicle data.

The vehicle data detected by the control computer can preferably describe states of further vehicle components. The vehicle data of said further vehicle components can also be transmitted by the control computer to the server computer for analysis purposes. Consequently, the server computer is not only in a position to establish and to assess the state of an individual vehicle component, but also the state of an assembly made up of various vehicle components and, finally, the state of the entire vehicle by evaluating the collected vehicle data.

The vehicle components can, on the one hand, be active component parts which can detect their state themselves and transmit the latter in the form of vehicle data to the control computer. The control computer can query the vehicle data detected by the active component parts and transmit said vehicle data to the server computer. The vehicle components can, on the other hand, be designed as passive component parts which cannot detect their state themselves. These include, for example, shafts, wishbones and other component parts. According to a preferred embodiment, it is also possible to deduce the state of the passive component parts by evaluating the vehicle data of the active component parts in the server computer.

Furthermore, it is possible to authenticate a vehicle by means of evaluating the vehicle data by the server computer, since the respective vehicle data of the vehicles depict the intrinsic, individual behavior of each vehicle. It is very difficult to manipulate or falsify the vehicle data since the data would have to be manipulated both on the server computer and in the vehicle itself in order to deceive the system. Consequently, the system makes it possible to clearly and reliably authenticate vehicles, thereby making it virtually impossible to falsify vehicle data and vehicle components.

According to a possible embodiment of the system, the server computer can be configured, following analysis of the vehicle data, to produce a command signal as a function of the established state of the vehicle component and/or of an assembly made up of various vehicle components and/or of the vehicle, which command signal is transmitted to the vehicle. The control computer is configured to control the vehicle component and/or assembly as a function of the command signal. Consequently, specific functionalities in the vehicle can be altered or deactivated in a targeted manner. In particular, countermeasures can be taken by the server computer, initiated as a function of the ascertained state of a vehicle component and/or of an assembly made up of multiple vehicle components and/or of the vehicle, if this is necessary.

According to a further embodiment of the system, the server computer can, as a function of the established state of the vehicle component and/or of an assembly made up of multiple vehicle components and/or of the entire vehicle, produce a state describing signal which is transmitted to the vehicle. Consequently, the state of the vehicle component and/or of the assembly and/or of the vehicle ascertained by the server computer can be displayed to a driver on a display device, for example a multimedia system, in the vehicle.

According to a further embodiment, the system comprises a data processing device which is arranged outside of the server computer and outside of the vehicle. The server computer can transmit the state describing signal not only to the vehicle itself, but also to the data processing device. As a function of the state describing signal, the data processing device provides information which characterizes a state of the vehicle component and/or of the assembly and/or of the vehicle. Moreover, recommendations for necessary maintenance processes or indications of a possible cause of the fault can be provided. The information can be provided both to a driver or vehicle owner and to service personnel of a vehicle maintenance company or a test center. The information can be displayed, for example, on a PC, a tablet or smartphone.

The required computing power for establishing the state of a vehicle component and/or of an assembly of vehicle components and/or of the entire vehicle is transmitted to a server computer on a back-end side of the system with the system according to the embodiment. The server computer used in the back-end provides greater and, as a general rule, more cost-effective computing power than if each vehicle were to assess the state of its vehicle components itself.

The vehicle data is solely detected on a client side of the system by the control computer of the vehicle in the vehicle itself. The detected vehicle data are combined on the client side in the vehicle or by the server computer on the back-end side of the system in such a way that, by analyzing them, it is possible to ascertain distinguishable vehicle system states which can be assessed by the server computer.

The system makes it possible to intelligently monitor the vehicle and its internal systems, that is to say individual vehicle components/component parts or more complex assemblies, in terms of road safety and conformity with prescribed regulations. Furthermore, the system makes it possible to carry out an online assessment of the state of individual vehicle component parts and of assemblies. Consequently, the system offers assistance when judging the state of a vehicle and, moreover, an increase in road safety by initiated countermeasures to remedy faults or by switching off/deactivating vehicle systems.

Messages or information with respect to the state of individual vehicle components and/or assemblies made up of multiple vehicle components and/or of the entire vehicle or indications and recommendations can be output on a front-end side of the system on units which are used by a system user outside of the vehicle. These include, by way of example, smartphones, tablets or desktop PCs. The user front-end can, for example, also be integrated into the vehicle's multimedia system. In this case, the information which characterizes the state of a vehicle component and/or of an assembly and/or of the entire vehicle, or other indications and recommendations, is/are displayed on a screen of the multimedia system in the vehicle.

The state information transmitted by the server computer can also be utilized on the front-end side of the system as a basis for a remote test and acceptance of vehicles by official testers. Reliable predictions with respect to wear and the likely occurrence of faults can be made on the basis of the data analysis by the server computer on the back-end side of the system, digitized expert knowledge and continuous improvement of remote monitoring and assessment over the life cycle of a vehicle system.

The assessment results established on the back-end side by the server computer can be utilized for a plurality of services. These include, by way of example, insurance bonus systems for “good vehicle care”. Furthermore, the system can be used by fleet management and leasing systems in order to judge the value of a vehicle by predicting necessary maintenance processes and to assess and improve the state of the vehicle systems by continuously monitoring the vehicles in the field.

### BRIEF DESCRIPTION OF THE DRAWINGS

Aspects of the embodiments are explained in more detail below on the basis of the drawings, in which:

FIG. 1 is a diagram illustrating a system for detecting a state of a vehicle component, according to an embodiment;

FIG. 2 is a diagram illustrating a division of state assessments of assemblies or individual vehicle components with respect to functionality and possible faults, according to an embodiment;

FIG. 3 is a diagram illustrating an exemplary division of vehicle systems into assemblies and individual vehicle components, according to an embodiment; and

FIG. 4 is a diagram illustrating a classification of states of vehicle components for different intended applications of the system, according to an embodiment.

### DETAILED DESCRIPTION

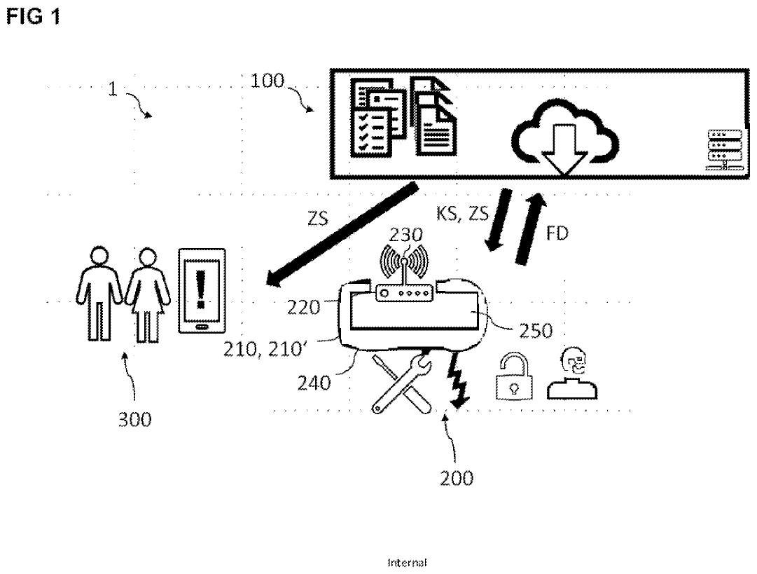

The architecture of a system 1 for detecting a state of a vehicle component is shown in FIG. 1. The system comprises a server computer 100 on a back-end side of the system and a vehicle 200 having a vehicle component 210 on a client side of the system. The vehicle 200 can be, by way of example, a road or rail vehicle, for example a car or a train, or any other vehicle. The vehicle 200 comprises a control computer 220 for controlling the vehicle component 210 and for detecting vehicle data FD which describe a state of the vehicle component 210. Furthermore, the vehicle comprises a data transmission device 230 for transmitting the vehicle data FD to the server computer 100 on the back-end side of the system.

The server computer 100 is configured to receive the vehicle data FD and to evaluate the vehicle data. The server computer 100 is in particular configured to establish a state of the vehicle component 210 by evaluating the vehicle data FD.

According to a further embodiment of the system 1, the server computer 100 is configured to carry out an authentication of the vehicle by evaluating the vehicle data FD. This is made possible in that the vehicle data differ individually for each vehicle and, consequently, represent a “fingerprint” of the vehicle. Falsifications or manipulations of the vehicle data and of the vehicle systems, by way of example an unauthorized utilization of functions which are licensed for another vehicle, can be advantageously exposed by the authentication of a vehicle, which is thus made possible.

The control computer 220 on the client side of the system 1 is configured to detect the vehicle data FD in such a way that the vehicle data also describe the states of further vehicle components 210′ which differ from the vehicle component 210. The server computer 100 on the back-end side of the system is configured to, consequently, establish not only a state of the vehicle component 210, but also the respective state of a plurality of further vehicle components 210′ by evaluating the vehicle data FD.

Moreover, the server computer 100 is configured to establish a state of an assembly 240 made up of the vehicle component 210 and the further vehicle components 210′ or a state of the entire vehicle 200. The vehicle data of the individual vehicle components are not only considered individually by the server computer 100. Instead, the vehicle data from a plurality of vehicle components 210, 210′ are evaluated together in order to, consequently, obtain the emerging behavior of the vehicle components or of an assembly made up of a plurality of vehicle components.

The vehicle component 210 can be configured as an active component part in such a way that the vehicle component provides the vehicle data for detecting by the control computer. Such active component parts can detect their state themselves and transmit the vehicle data characterizing the state to the control computer 220. At least one further vehicle component 210′ can be configured as a passive component part in such a way that the vehicle data is not provided by the further vehicle component. Passive component parts do not therefore supply any vehicle data which characterize their state to the control computer 220. According to a possible embodiment of the system, the server computer 100 is configured to establish a state of one of the further (passive) vehicle components 210′ by evaluating the vehicle data FD transmitted to it. Consequently, the state data, which are detected in the vehicle by the active vehicle components, are utilized by the server computer 100 in order to detect and to judge the state of the passive parts indirectly.

According to a possible embodiment of the system 1, the server computer 100 is in particular configured to establish or to assess a state of the vehicle component 210 and/or of an assembly 240 of various vehicle components and/or a state of the entire vehicle 200 with respect to roadworthiness and/or fulfillment of a conformity requirement, for example the conformity with legally prescribed road safety requirements, and/or a maintenance state and/or an integrity and/or the fulfillment of a safety requirement, by evaluating the vehicle data FD. This can be made possible by configuring the server computer 100 as a powerful computer on the back-end side of the system.

The control computer 220 on the client side of the system can have one or more computer processors which are arranged in the vehicle 200. The control computer 220 is configured to detect all of the vehicle data from a plurality of vehicle components which are required in order for the server computer on the back-end side of the system to judge the roadworthiness, the conformity with a requirements profile, the maintenance state, the integrity and, finally, the overall safety of the vehicle.

The vehicle data are obtained on the client side of the system from time-synchronized signals from measurement or sensor systems, for example, acceleration sensors, gyroscopes, wheel speed sensors, pressure sensors, temperature sensors, torque sensors, inside the vehicle. The vehicle data for the server computer 100 can be provided time-synchronously in that the detected vehicle data are equipped with time stamps so that the server computer 100 on the back-end side can correctly class the vehicle data transmitted to it in a temporal sequence.

The vehicle data can be transmitted to the server computer 100, sub-filtered as raw data or already pre-processed, for example filtered or altered in some other way, or in compressed form, for the purposes of reducing the bandwidth. The vehicle data can be transmitted by the control computer 220 with the aid of the data transmission device 230, by way of example wirelessly via a defined standard (LTE, G5, etc.), to the server computer 100 on the back-end side of the system. The vehicle data can either be transmitted continuously or, following a previous query by the server computer 100, from the control computer 220 to the back-end side of the system.

According to a possible embodiment of the system, the server computer 100 can be configured to produce a command signal KS and to transmit the command signal KS to the vehicle 200 as a function of the established state of the vehicle component 210 and/or of the assembly 240 made up of various vehicle components and/or as a function of the established state of the vehicle 200. The data transmission device 230 on the client side is configured to receive the command signal KS. The control computer 220 is configured to change a state of the vehicle component 210 and/or of the assembly 240 as a function of the command signal KS.

As a result, it is possible that, as a function of an assessment of the state of a vehicle component and/or of an assembly made up of multiple vehicle components and/or of the entire vehicle by the server computer 100, measures are initiated on the client side of the system in order to guarantee the road safety of the vehicle 200. The initiated measures include, by way of example, countermeasures for remedying faults of vehicle components, the controlled deactivation of specific vehicle functions, for example automated driving functions, carrying out software updates, the activation/deactivation of a motor, etc.

According to a further embodiment of the system, the server computer 100 can be configured to produce a state describing signal ZS, which contains a description of the established state of the vehicle component and/or of the assembly and/or of the entire vehicle, as a function of the established state of the vehicle component 210 and/or of the assembly 240 and/or of the vehicle 200.

The server computer 100 can be configured to transmit the state describing signal ZS to the vehicle 200. Furthermore, the data transmission device 230 in the vehicle can be configured to receive the state describing signal ZS.

A display device 250 can be arranged in the vehicle 200 on a front-end side of the system 1. The control computer 200 is configured to display a message on the display device 250 as a function of the state describing signal ZS. As a result, messages which are connected to the analysis and assessment of the vehicle data by the server computer 100 can, for example, be displayed on onboard systems inside the vehicle 200.

According to a possible embodiment, the server computer 100 can be configured to store the transmitted vehicle data for a (longer) period of time. The server computer 100 can, in particular, be configured to create data characterizing a vehicle profile of a vehicle by evaluating the vehicle data FD stored over the period of time. The data characterizing the vehicle profile can contain vehicle configuration-specific data and/or user-specific data and/or wear-specific data and/or data describing the dynamic behavior of a vehicle component and/or of an assembly.

Consequently, vehicle data transmitted by the vehicle 200, which reflect a vehicle history and from which a vehicle profile can be determined, are continuously collected by the server computer 100. The recorded vehicle data and the data characterizing the vehicle profile from a plurality of vehicles 200 can be stored and updated by the server computer 100 on the back-end side of the system.

The server computer 100 is configured to compare the transmitted vehicle data FD with the vehicle data stored over the (longer) period of time and/or the data characterizing the vehicle profile, and to establish the state of the vehicle component 210 and/or of the assembly 240 and/or of the vehicle 200 on the basis of the comparison. By evaluating the currently received vehicle data and by comparing said current data with the recorded historical and vehicle-specific data which are stored on the back-end side, the server computer 100 can, consequently, assess the integrity of the individual vehicle components or assemblies. Moreover, the probability of a component failure, a critical state of wear of a vehicle component or an illegal manipulation of a vehicle component can be ascertained by the server computer 100.

If a critical event, by way of example wear, manipulation or the malfunction of a vehicle component or of an assembly is ascertained, a corresponding command signal KS or a state describing signal ZS can be sent to the control computer 220 on the client side of the system.

According to a possible embodiment, the system 1 has a data processing device 300, on the front-end side of the system, which is arranged outside of the server computer 100 and outside of the vehicle 200. The data processing device 300 is configured to receive the state describing signal ZS and to provide information as a function of the state describing signal. With the aid of the state describing signal ZS, information can be structured and processed by the server computer 100 in order to be transmitted to the front-end side of the system 1 depending on the intended application.

The data processing device 300 on the front-end side of the system can be, by way of example, a smartphone, a tablet or a user's PC. As a function of the state describing signal ZS, information about the state of a vehicle component and/or of an assembly and/or of the vehicle can be displayed on one of said units. Furthermore, additional information relating to necessary vehicle maintenance, possible countermeasures for remedying breakdowns or information regarding a recommended vehicle service, etc., can also be displayed.

The information can be displayed or made available to a driver or vehicle owner, or to the service personnel of a workshop or to an official tester of an authorized test center on the front-end side of the system via the data processing device 300. The data processing device 300 on the front-end side of the system can consequently be deployed for the vehicle inspection, in particular a remote inspection of the vehicle on the basis of the collected vehicle data and the analysis thereof by an official test center. In order to carry out such a remote vehicle inspection, the change in state of all safety-relevant vehicle components is observed by the server computer 100.

According to a possible embodiment of the system 1, the server computer 100 is configured to calculate data which characterize the behavior to be expected of the vehicle component 210 and/or of the assembly 240. The server computer 100 is configured to establish the state of the vehicle component 210 and/or of the assembly 240 and/or of the vehicle 200 in that the server computer 100 compares the data characterizing the behavior to be expected with the transmitted vehicle data FD.

The actual, measured behavior of the various vehicle components can be established by the server computer 100 from the vehicle data FD transmitted by the vehicle 200. The behavior to be expected is likewise established by the server computer 100 from the transmitted vehicle data FD with the aid of mathematical models. In particular, the mathematical models describe the transmission behavior of the individual vehicle components and their coupling with one another.

Such mathematical models can be created from the physical properties of the vehicle components and their interaction. A further possibility for extracting the mathematical models consists of evaluating measured vehicle data from reference vehicle systems, with the help of machine learning techniques. Furthermore, models based on known physical effects of defects in the transmission behavior of vehicle components can be used in order to capture and to classify faults of individual vehicle components or of entire assemblies.

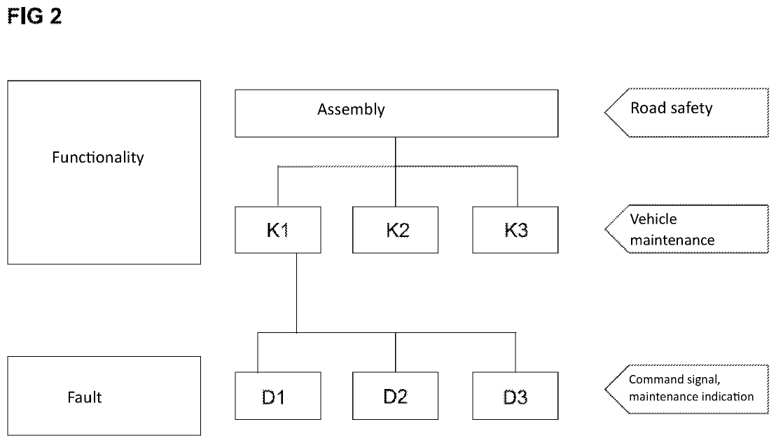

FIG. 2 illustrates how the functionality of an entire assembly with respect to road safety or the functionality of individual components of the assembly in relation to any necessary vehicle maintenance can be assessed by appropriate evaluation by means of the server computer 100 on the server side of the system. In addition, definite faults in a specific vehicle component can be established by further evaluation of the transmitted vehicle data on the server side.

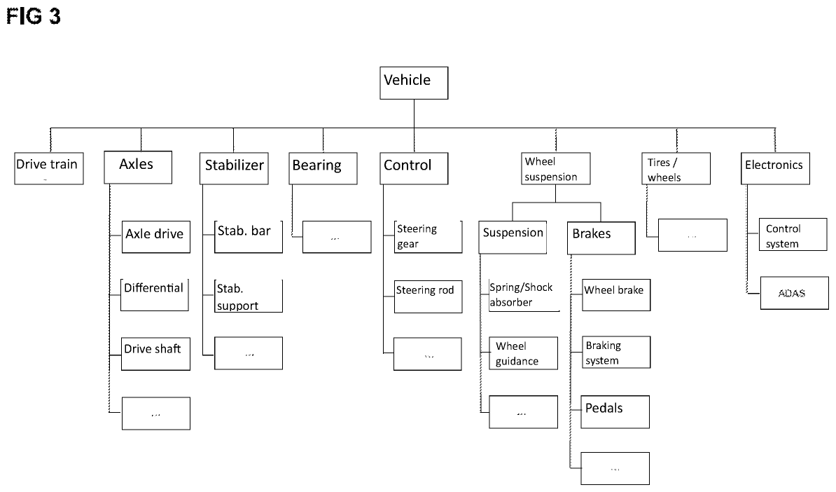

FIG. 3 illustrates a subdivision of a vehicle into individual vehicle assemblies and the vehicle components thereof.

As a function of the ascertained fault in a component, a command signal to initiate a countermeasure to remedy the ascertained fault or a maintenance indication can be transmitted to the control computer 220 on the client side of the system by the server computer. In particular, the states of assemblies or the components thereof and possible causes of faults can be established and judged by the server computer, by utilizing linked mathematical models.

The evaluation of the behavior to be expected of specific vehicle components or assemblies, compared with the measured behavior of the corresponding vehicle components or assemblies and the definite ascertainment of a fault pattern can advantageously provide information in order to decide whether a scheduled inspection of a vehicle can be postponed or which maintenance measures are necessary or whether an ascertained state requires an immediate restriction or even shutdown of the driving operation of the vehicle.

In order to take account of tolerances of vehicle components or measurement systems during the analysis of the vehicle data on the back-end side of the system, the system can be trained at the start of a vehicle's lifecycle or after a change in configuration. As a result, the vehicle data supplied by the individual vehicles can be individually analyzed and assessed, taking account of a tolerance in the behavior of the vehicle components. Furthermore, the system can be deployed at the end of a manufacturing process of the vehicle in order to demonstrate that the vehicle components are functioning as intended.

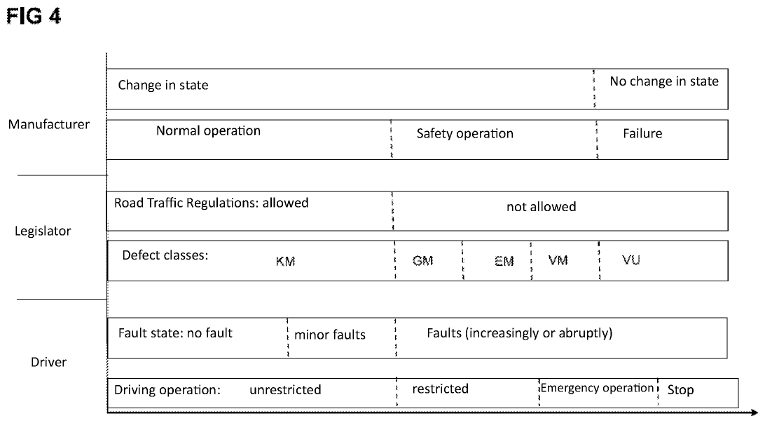

The information made available by the system regarding a state, a change in state or a fault state of a vehicle component and/or of an assembly made up of multiple vehicle components can be utilized for various intended applications. FIG. 4 shows, by way of example, how the information made available by the system can be used by a manufacturer, a legislator or a driver.

As a function of an established change in the state of a vehicle component and/or of an assembly, a vehicle manufacturer can, by way of example, determine the recommended operation of the vehicle. As a function of a classification of a defect provided by the system (by way of example: KM=no defect, GM=minor defect, EM=significant defect, VM=dangerous defect, VU=unroadworthy state), a legislator can issue or refuse a certificate for driving the vehicle on the road. As a function of the fault state of a vehicle component and/or of an assembly established by the system, a driver can determine the permissible driving operation of the vehicle.

1. A system for detecting a state of a vehicle component, the system comprising:
a server computer;
a vehicle component of the vehicle;
control computer of the vehicle, the control computer configured to control the vehicle component and detect vehicle data describing a state of the vehicle component; and
a data transmission device configured to transmit the vehicle data to the server computer,
wherein the server computer is configured to receive the vehicle data, evaluate the vehicle data, and establish a state of the vehicle component based on a result of evaluating the vehicle data.

2. The system according to claim 1, wherein the server computer is configured to authenticate the vehicle based on the result of evaluating the vehicle data.

3. The system according to claim 2, wherein the vehicle data describes states of further vehicle components which differ from the vehicle component, and
wherein the server computers is configured to establish a state of the vehicle and/or of an assembly made up of the vehicle component and the vehicle components by based on the result of evaluating the vehicle data.

4. The system according to claim 3, wherein the vehicle components is configured in to provide the vehicle data for detecting by the control computer,
wherein at least one vehicle component of the further vehicle components is configured in not to provide the vehicle data, and
wherein the server computer is configured to establish a state of the at least one vehicle component based on the result of evaluating the vehicle data.

5. The system according to claim 4, wherein the server computer is configured to produce a command signal and transmit the command signal to the vehicle as a function of the established state of the vehicle component and/or of the assembly and/or of the vehicle.

6. The system according to claim 5, wherein wherein the data transmission device is configured to receive the command signal, and
wherein the control computer is configured to change a state of the vehicle component and/or of the assembly as a function of the command signal.

7. The system according to claim 6, wherein the server computer is configured to produce a state describing signal containing a description of the established state of the vehicle component and/or of the assembly and/or of the vehicle, as a function of the established state of the vehicle component and/or of the assembly and/or of the vehicle.

8. The system according to claim 7, wherein the server computer is configured to transmit the state describing signal to the vehicle,
wherein the data transmission device is configured to receive the state describing signal,
wherein the vehicle comprises a display device, and
wherein the control computer is configured to control the display device to display a message on the display device as a function of the state describing signal.

9. The system according to claim 8, further comprising:
a data processing device external to the server computer and outside of the vehicle,
wherein the data processing device is configured to receive the state describing signal and to provide information as a function of the state describing signal.

10. The system according to claim 9, wherein the server computer is configured to establish a state of the vehicle component and/or of the assembly 2 and/or of the vehicle with respect to roadworthiness and/or a conformity requirement and/or a maintenance state and/or an integrity and/or a safety requirement by evaluating the vehicle data.

11. The system according to claim 10, wherein the server computer is configured to store the transmitted vehicle data for a period of time.

12. The system according to claim 11, wherein the server computer is configured to create data characterizing a vehicle profile of the vehicle by evaluating the vehicle data stored over the period of time, and
wherein the data characterizing the vehicle profile contain vehicle configuration-specific data and/or user-specific data and/or wear-specific data and/or data describing the dynamic behavior of the vehicle component and/or of the assembly.

13. The system according to claim 12, wherein the server computer is configured to compare the transmitted vehicle data with the vehicle data stored over the period of time and/or the data characterizing the vehicle profile, and to establish the state of the vehicle component and/or of the assembly and/or of the vehicles on the basis of the comparison.

14. The system according to claim 13, wherein the server computer is configured to calculate data which characterize the behavior to be expected of the vehicle component and/or of the assembly, and
wherein the server computer is configured to establish the state of the vehicle component and/or of the assembly and/or of the vehicle, in that the server computer compares the data characterizing the behavior to be expected with the transmitted vehicle data.

15. The system according to claim 14, wherein the server computer is configured to establish the data characterizing the behavior to be expected by means of mathematical models.
